(19) United States
(12) Patent Application Publication
(10) Pub. No.: US 2021/0192319 A1
(43) Pub. Date: Jun. 24, 2021

(54) INFORMATION PROCESSING APPARATUS, METHOD, AND MEDIUM

(71) Applicant: PFU LIMITED, Kahoku-shi (JP)

(72) Inventor: Yudai Asai, Kahoku-shi (JP)

(73) Assignee: PFU LIMITED, Kahoku-shi (JP)

(21) Appl. No.: 17/192,031

(22) Filed: Mar. 4, 2021

Related U.S. Application Data
(63) Continuation of application No. PCT/JP2018/033012, filed on Sep. 6, 2018.

(51) Int. Cl. G06N 3/04

(52) U.S. Cl. CPC G06N 3/04

(57) ABSTRACT

An information processing apparatus performing operation of a convolutional neural network executes: determining a first bin width on the basis of a maximum value in a plurality of pieces of data represented in a floating point format; creating a bin range determination histogram by assigning each of the plurality of pieces of data to each bin on the basis of the first bin width; determining a bin range, within which a predetermined percentage or more of the plurality of pieces of data fall, by referring to the bin range determination histogram; determining a second bin width on the basis of the number of pieces of data in the bin range; and creating a reference histogram by assigning each of a plurality of pieces of data in the bin range to each bin on the basis of the second bin width.

### CROSS-REFERENCE TO RELATED APPLICATION

This application is a continuation application of International Application PCT/JP2018/033012 filed on Sep. 6, 2018, and designated the U.S., the entire contents of which are incorporated herein by reference.

### FIELD

The present disclosure relates to a convolutional neural network technique.

### BACKGROUND

In recent years, attention has been focused on deep learning, particularly on a convolutional neural network (hereinafter referred to as “CNN”).

In general, in representation of each data of input/weight coefficient/output in the CNN, floating point number representation (32 bit float; hereinafter referred to as “FP32”) is used in training/inference.

However, the scale of logic needed in operation in the floating point number representation is large, hence, in order to reduce the logic scale, the CNN, in which fixed point number representation (e.g., 8 bit integer; hereinafter referred to as “INT8”) is used in at least part of the logic, and the CNN, in which output is binarized, have been proposed (With regard to the CNN in which the output is binarized, see Japanese Patent Application Publication No. 2016-235383 and Japanese Patent Application Publication No. 2017-211972).

Herein, in order to reduce a quantization error when the fixed point number representation is applied to the CNN, a method is proposed in which, after training of the CNN is performed, inference based on a small data set is performed in advance to predict input/output data distributions in each layer, and a scale factor for conversion from a dynamic range of FP32 to a dynamic range of INT8 is determined by statistical analysis (see Japanese Patent Application Publication No. 2018-010618).

In general, the fixed point number representation has a single scale factor. However, it is pointed out that in the CNN, the data distribution of each of input/weight coefficient/output significantly differs depending on the layer of the neural network, hence, when the signal scale factor is used in the CNN and at the same time the number of bits of the fixed point number representation is reduced, recognition accuracy is sharply reduced (see P. Gysel, J. Pimentel, M. Motamedi, and S. Ghiasi. Ristretto: A Framework for Empirical Study of Resource-Efficient Inference in Convolutional Neutral Networks. IEEE Transactions on Neural Networks and Learning Systems, 2018). In addition, in P. Gysel, J. Pimentel, M. Motamedi, and S. Ghiasi. Ristretto: A Framework for Empirical Study of Resource-Efficient Inference in Convolutional Neutral Networks. IEEE Transactions on Neural Networks and Learning Systems, 2018, it is reported that, by using the scale factor which differs from one layer to another in the neural network, even in a case where the number of bits of the fixed point number representation is small, it is possible to maintain the recognition accuracy at a level substantially equal to that in a case where the floating point number representation is used.

As one of specific algorithms for determining the scale factor used in the above method, so-called “entropy calibration” has been proposed (see Szymon Migacz.8-bit Inference with TensorRT. http://on-demand.gputechconf.com/gtc/2017/presentation/s7310-8-bit-inference-with-tensorrt.pdf).

Conventionally, in order to reduce the quantization error as much as possible when the fixed point number representation is applied to the CNN, a method is proposed in which, after training of the CNN has been performed, inference based on a small data set for calibration is performed in advance to predict the input/output data distributions of each layer, and the scale factor for conversion from the dynamic range of the floating point number representation to the dynamic range of the fixed point number representation is determined by statistical analysis and, as one of specific algorithms for determining the scale factor, a method which is referred to as so-called entropy calibration has been proposed.

The entropy calibration is a method in which inference based on the data set for calibration is performed first by using the floating point number representation, and the scale factor which minimizes loss of information between distributions of individual pieces of data of individual layers obtained by the inference and distributions obtained by quantizing the above distributions is calculated.

However, even when the entropy calibration is used, for example, in a case where a data set which causes an extreme outlier is used or a case where a so-called rectified linear unit (ReLU) function (ϕ(x)=max(0, x)) is used as an activating function, a problem arises in that recognition accuracy is reduced.

### SUMMARY

An example of the present disclosure is an information processing apparatus performing operation of a convolutional neural network, the information processing apparatus including: first bin width determination means for determining a first bin width on the basis of a maximum value in a plurality of pieces of data represented in a floating point format; bin range determination histogram creation means for creating a bin range determination histogram by assigning each of the plurality of pieces of data to each bin on the basis of the first bin width; range determination means for determining a bin range within which a predetermined percentage or more of the plurality of pieces of data fall by referring to the bin range determination histogram; second bin width determination means for determining a second bin width on the basis of the number of pieces of data in the bin range; and reference histogram creation means for creating a reference histogram by assigning each of a plurality of pieces of data in the bin range to each bin on the basis of the second bin width.

An example of the present disclosure is an information processing apparatus performing operation of a convolutional neural network, the information processing apparatus including: data acquisition means for acquiring data represented in a floating point format, in which a negative value included in a convolution operation result is replaced with 0; and reference histogram creation means for creating a reference histogram by assigning, among a plurality of pieces of data, a piece of data having a value other than 0 to each bin on the basis of a predetermined bin width, and not assigning, among the plurality of pieces of data, a piece of data having a value 0 to any of the bins.

The present disclosure can be understood as an information processing apparatus, a system, a method which is executed by a computer, or a program which a computer is caused to execute.

In addition, the present disclosure can also be understood as such a program recorded in a recording medium which can be read by a computer, other apparatuses, and machines.

Herein, the recording medium which can be read by the computer and the like denotes a recording medium capable of accumulating information such as data and a program with electrical, magnetic, optical, mechanical, or chemical action and reading the information from the computer and the like.

### BRIEF DESCRIPTION OF THE DRAWINGS

FIG. 1 is a schematic view showing the hardware configuration of a CNN processing system according to an embodiment;

FIG. 2 is a view showing the outline of CNN processing according to the embodiment;

FIG. 3 is a view showing the outline of the functional configuration of the CNN processing system according to the embodiment;

FIG. 4 is a flowchart (A) showing the outline of the procedure of calibration processing according to the embodiment;

FIG. 5 is a flowchart (B) showing the outline of the procedure of the calibration processing according to the embodiment;

FIG. 6 is a flowchart showing the outline of the procedure of zero data exclusion processing according to the embodiment;

FIG. 7 is a view (A) showing a reference histogram created with conventional entropy calibration;

FIG. 8 is a view (B) showing a reference histogram created with the conventional entropy calibration;

FIG. 9 is a view (C) showing a reference histogram created with the conventional entropy calibration;

FIG. 10 is a view (A) showing a reference histogram created with calibration which adopts the zero data exclusion processing;

FIG. 11 is a view (B) showing a reference histogram created with the calibration which adopts the zero data exclusion processing;

FIG. 12 is a view (C) showing a reference histogram created with the calibration which adopts the zero data exclusion processing;

FIG. 13 is a view showing an example of a reference histogram created with the conventional entropy calibration;

FIG. 14 is a view showing an example of a reference histogram in the case where a maximum value of an absolute value is rewritten to a value which is 100 times the maximum value in the conventional entropy calibration;

FIG. 15 is a view showing a state in which Step S106 of the calibration processing according to the present embodiment is executed based on the histogram in FIG. 14;

FIG. 16 is a view showing a reference histogram P₂ created with the calibration processing according to the embodiment;

FIG. 17 is a view showing a candidate histogram Q created based on the reference histogram P₂ in FIG. 16 when the Kullback-Leibler divergence is minimized;

FIG. 18 is an enlarged view of a top ¼ portion of FIG. 16; and

FIG. 19 is an enlarged view of a top ¼ portion of FIG. 17.

### DESCRIPTION OF EMBODIMENTS

Hereinbelow, the mode of implementation of an information processing apparatus, a method, and a program according to the present disclosure will be described based on the drawings. Note that the mode of implementation described below describes an embodiment by way of example, and the mode of implementation is not intended to limit each of the information processing apparatus, the method, and the program according to the present disclosure to a specific configuration described below. In addition, in the implementation, the specific configuration corresponding to the mode of implementation is appropriately adopted, and various improvements and modifications may be made.

In the description of the embodiment, a description will be given of the mode of implementation in the case where the information processing apparatus, the method, and the program according to the present disclosure are implemented in a system for performing operation of a convolutional neural network. Note that the information processing apparatus, the method, and the program according to the present disclosure can be widely used in a neural network technique, and an application target of the present disclosure is not limited to an example described in the embodiment.

System Configuration

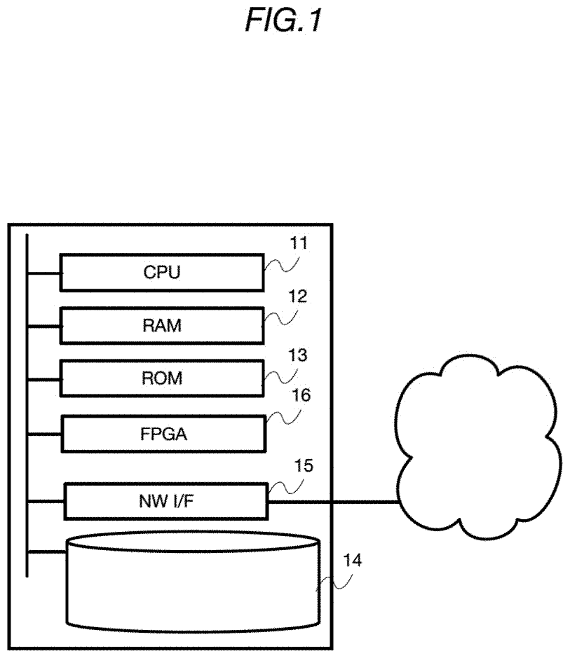

FIG. 1 is a schematic view showing the hardware configuration of a convolutional neural network (CNN) processing system 1 according to the present embodiment. The CNN processing system 1 according to the present embodiment is a computer which includes a central processing unit (CPU) 11, a random access memory (RAM) 12, a read only memory (ROM) 13, a storage device 14 such as an electrically erasable and programmable read only memory (EEPROM) or a hard disk drive (HDD), a communication unit 15 such as a network interface card (NIC), and a field-programmable gate array (FPGA) 16.

While a GPU is widely used in training/inference of the CNN, there are cases where a programmable device such as the FPGA is utilized in order to increase power efficiency. In the FPGA, fixed point number representation is often used in order to reduce a circuit scale. The CNN processing system 1 according to the present embodiment is a system in which scale factors (a conversion factor from a floating point number to a fixed point number) are used in individual layers of a neural network, the scale factor differs from one layer to another, and the FPGA is used as an accelerator from a host machine including a CPU.

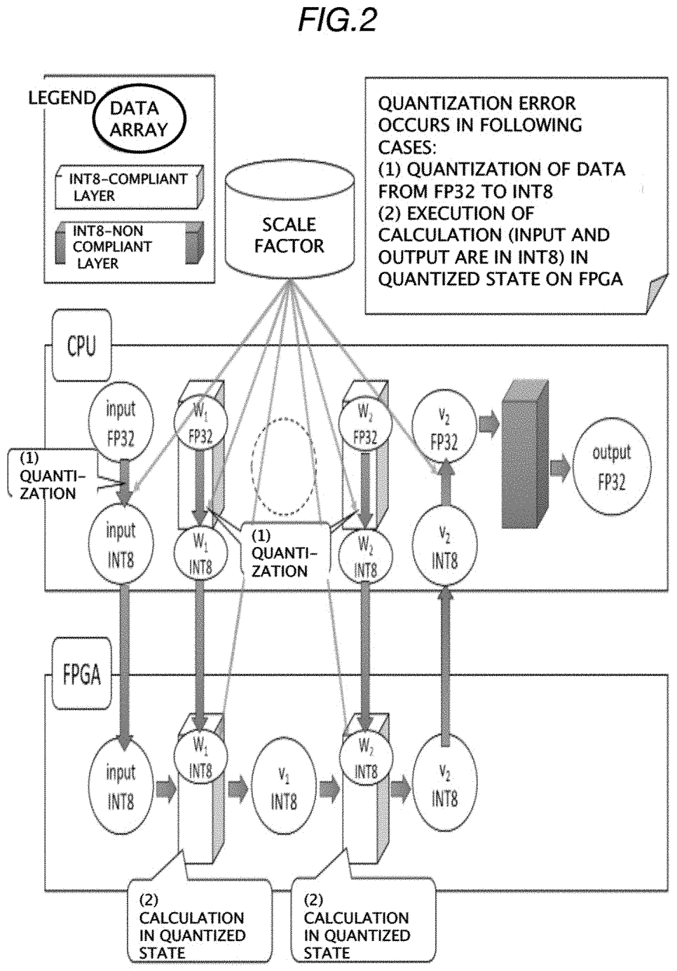

FIG. 2 is a view showing the outline of CNN processing according to the present embodiment. In the CNN processing system 1 according to the present embodiment, a part in which a quantization error occurs includes “(1) a part in which input data and a weight coefficient in FP32 are quantized to those in INT8”, and “(2) a part in which calculation is performed on the FPGA in a state in which the input data and the weight coefficient are quantized to those in INT8”. Among them, “(1) a part in which input data and a weight coefficient in FP32 are quantized to those in INT8” specifically denotes calculation expressed as the following formula. In the following formula, x is input in FP32, s is a scale factor (a scalar value in FP32), round(v) is a function which rounds a value v in FP32 to an integer closest to the value v, and clamp(v, a, b) is a function which returns a when an integer v is less than a, returns b when the integer v is greater than b, and returns v when the integer v is not less than a and not greater than b.

q=clamp(round(sx),−127,127)

One of specific algorithms for determining the scale factor is so-called entropy calibration, and the present algorithm has the following practical problems.

Problem 1: Use of ReLU Function

In the case of the CNN including a ReLU function, a peak occurs at a value 0 in a reference histogram created with conventional entropy calibration. This is because an entire negative portion of output is integrated into the single value 0 by the ReLU function. When such a data distribution is provided, the normalized frequency of a positive portion of the output is reduced, the scale factor becomes greater than an expected value, and an overflow or an underflow (the value has an integer value exceeding ±127 serving as an upper limit/a lower limit of INT8, and is clipped to ±127) frequently occurs. As a result, recognition accuracy is significantly reduced.

Problem 2: Use of Data Set which Causes Extreme Outlier

In the case where the conventional entropy calibration is applied to a data set which causes an extreme outlier, a bin width of a histogram of output data is extremely increased, many values are rounded to the same bin, and loss of information is thereby increased. As a result, recognition accuracy is significantly reduced.

The CNN processing system 1 disclosed in the present embodiment solves the practical problems of the conventional entropy calibration.

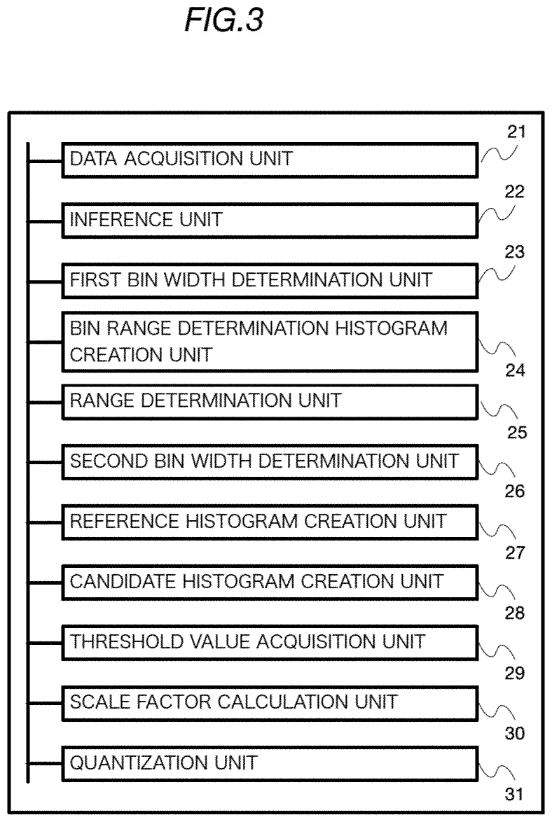

FIG. 3 is a view showing the outline of the functional configuration of the CNN processing system 1 according to the present embodiment. A program recorded in the storage device 14 is read by the RAM 12 and executed by the CPU 11 and/or the FPGA 16 and each hardware provided in a server 50 is controlled, whereby the CNN processing system 1 functions as an information processing apparatus including a data acquisition unit 21, an inference unit 22, a first bin width determination unit 23, a bin range determination histogram creation unit 24, a range determination unit 25, a second bin width determination unit 26, a reference histogram creation unit 27, a candidate histogram creation unit 28, a threshold value acquisition unit 29, a scale factor calculation unit 30, and a quantization unit 31. Note that, in the present embodiment and other embodiments described later, the individual functions of the CNN processing system 1 are executed by the CPU 11 and/or the FPGA 16 which is a general-purpose processor, but part or all of the functions may also be executed by one or a plurality of dedicated processors.

The data acquisition unit 21 acquires a data set (a plurality of pieces of data) which is represented in a floating point format (e.g., FP32) and is used in convolution operation. Note that, in the data set acquired by the data acquisition unit 21, there are cases where a negative value in the data set is replaced with 0 by the ReLU function. In the present embodiment, in the case where the negative value in the data set is converted to 0 by the ReLU function, each of the histogram creation units 24, 27, and 28 (the bin range determination histogram creation unit 24, the reference histogram creation unit 27, and the candidate histogram creation unit 28) described later creates a histogram by assigning data having a value other than 0 to each bin based on a predetermined bin width and not assigning data having a value 0 to the bin.

The inference unit 22 performs inference related to an input data set according to a general convolutional neural network method, and outputs the inference result as a data set.

The first bin width determination unit 23 determines a first bin width Δ₁ by dividing a maximum value in a plurality of pieces of data represented in the floating point format by the predetermined number of bins.

The bin range determination histogram creation unit 24 creates a bin range determination histogram P₁ by assigning the plurality of data to individual bins based on the first bin width Δ₁.

The range determination unit 25 determines a bin range (a bin position X in the present embodiment) within which a predetermined percentage (e.g., 99.99%) or more of the plurality of pieces of data fall by referring to the bin range determination histogram P₁.

The second bin width determination unit 26 determines a second bin width Δ₂ by dividing a value obtained by multiplying the number of pieces of data in the bin range (at or below the bin position X in the present embodiment) by the first bin width Δ₁ by the predetermined number of bins.

The reference histogram creation unit 27 creates a reference histogram P₂ by assigning a plurality of pieces of data in the bin range to individual bins based on the second bin width Δ₂.

The candidate histogram creation unit 28 creates a candidate histogram Q by assigning a plurality of pieces of data to any number of bins i without converting the floating point format of the plurality of pieces of data.

The threshold value acquisition unit 29 compares a distribution in the reference histogram P₂ with a distribution in the candidate histogram Q, and acquires a threshold value t which reduces a difference between the distributions.

The scale factor calculation unit 30 calculates a scale factor for converting a plurality of pieces of data represented in the floating point format to a plurality of pieces of data represented in a predetermined fixed point format (e.g., INT8) based on the threshold value t acquired by the threshold value acquisition unit 29 and the number of levels which can be represented in the predetermined fixed point format.

The quantization unit 31 converts a plurality of pieces of data to a plurality of pieces of data represented in the fixed point format by quantizing data in a range in which a value is determined by the threshold value t to data in a range below a maximum value or above a minimum value which can be represented in the predetermined fixed point format and assigning data outside the range in which the value is determined by the threshold value t to the maximum value or the minimum value. In the present embodiment, the quantization unit 31 converts a plurality of pieces of data represented in the floating point format to a plurality of pieces of data represented in the predetermined fixed point format by using the scale factor calculated by the scale factor calculation unit 30.

Procedure of Processing

Next, a description will be given of the procedure of processing executed by the CNN processing system 1 according to the present embodiment. Note that the specific content and processing order of the processing described below are examples for implementing the present disclosure. The specific processing content and processing order may be appropriately selected according to the mode of implementation of the present disclosure.

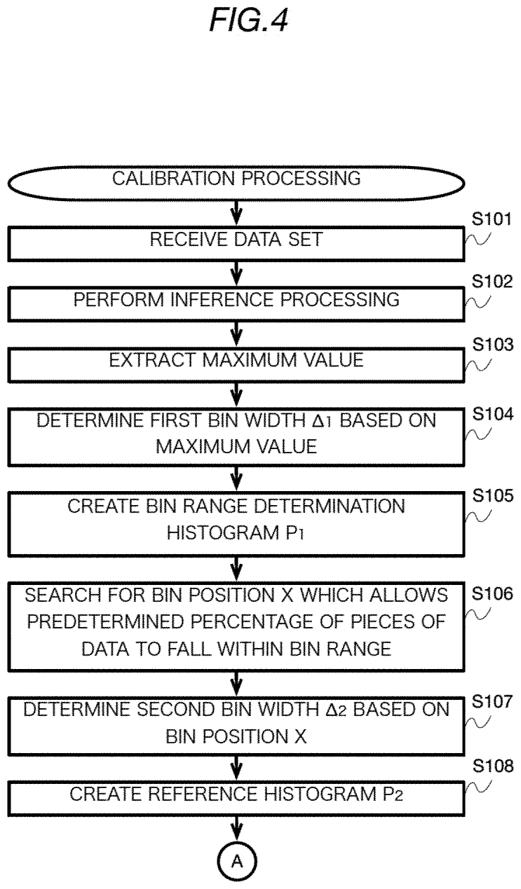

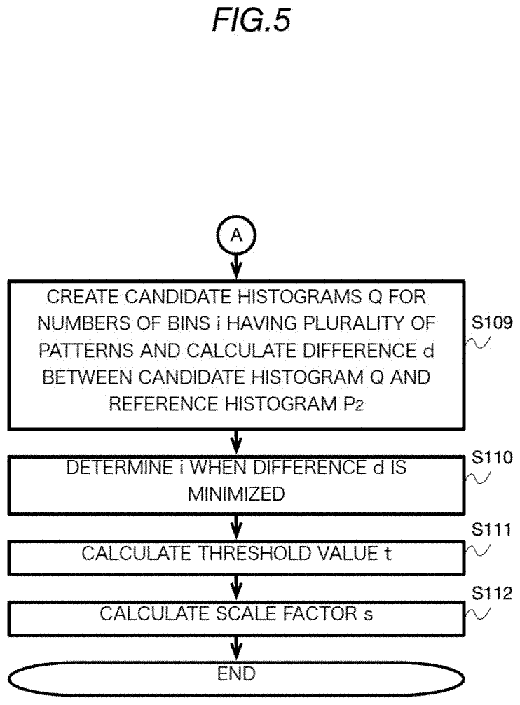

Each of FIGS. 4 and 5 is a flowchart showing the outline of the procedure of calibration processing according to the present embodiment. The processing shown in the present flowchart is executed at the time of creation of histograms of input/output data of each layer in the CNN.

In Step S101 and Step S102, reception of a data set for calibration and inference based on the data set are performed. When a small data set for calibration is received by the data acquisition unit 21 (Step S101), the inference unit 22 performs inference related to the data set in the floating point format (e.g., FP32) by using a learned parameter (Step S102). Thereafter, the processing proceeds to Step S103.

Thereafter, steps of the processing shown in Step S103 to Step S112 are performed on all data (absolute values thereof) of output of Step S102 for each layer, and an adequate scale factor is thereby determined. Note that the data to be processed is data in the floating point format (e.g., FP32) except subscripts of an array, and conversion to the fixed point format (e.g., INT8) or the like is not performed in the processing shown in the present flowchart.

In Step S103 to Step S105, the bin range determination histogram P₁ is created. First, the first bin width determination unit 23 extracts a maximum value in all data (absolute values thereof) of the output (Step S103). Subsequently, the first bin width determination unit 23 determines the first bin width Δ₁ of the histogram based on the maximum value (Step S104). Specifically, the first bin width determination unit 23 determines the first bin width Δ₁ based on a value obtained by dividing the maximum value extracted in Step S103 by the number of bins of the histogram to be created. For example, in the case where the maximum value is 10000 and the number of bins is 2048, the first bin width Δ₁ is determined to be 4.8828125.

When the first bin width Δ₁ is determined, the bin range determination histogram creation unit 24 creates the bin range determination histogram P₁ by assigning a plurality of pieces of data obtained in Step S102 to individual bins based on the determined first bin width Δ₁ (Step S105). Thereafter, the processing proceeds to Step S106.

In Step S106 to Step S108, the reference histogram P₂ is created. First, the range determination unit 25 refers to the bin range determination histogram P₁ created in Step S105 to search for the bin position X, which allows almost all (e.g., 99.99%) frequency values of the entire bin range determination histogram P₁ to fall, within the bin range with a bin position 0 used as a starting point (Step S106). Subsequently, the second bin width determination unit 26 determines the second bin width Δ₂ based on the bin position X (Step S107). Specifically, the second bin width determination unit 26 determines the second bin width Δ₂ based on a value obtained by dividing a value obtained by multiplying the number of pieces of data in a range up to the determined bin position X (bin range) by the first bin width Δ₁ by the number of bins of the histogram to be created.

When the second bin width Δ₂ is determined, the reference histogram creation unit 27 creates the reference histogram P₂ by assigning the plurality of pieces of data obtained in Step S102 to individual pins based on the determined second bin width Δ₂ (Step S108). Thereafter, the processing proceeds to Step S109.

In Step S109, the candidate histograms Q are created for the numbers of bins i having a plurality of patterns, and a difference between the candidate histogram Q and the reference histogram P₂ is determined. The candidate histogram creation unit 28 creates the candidate histogram Q by converting the plurality of pieces of data obtained in Step S102 to 128-gradation data, with the plurality of pieces of data being kept as-is to represented in the floating point format (in the case of INT8; quantization to the fixed point format is not performed) and assigning the data to i bins. At this point, the candidate histogram creation unit 28 uses individual integers which are in a range of the number of bins of the reference histogram P₂ and are multiples of the number of levels which can be represented in the predetermined fixed point format as the numbers of bins i, and creates a plurality of the candidate histograms Q for the numbers of bins i. For example, in the case where the number of bins of the reference histogram P₂ is 2048 and INT8 is used as the fixed point format, i has values [128, 256, 384, . . . , 2048]. Subsequently, the threshold value acquisition unit 29 calculates the Kullback-Leibler divergence d (a measure for measuring a difference in probability distribution) between each of the plurality of candidate histograms Q and the reference histogram P₂ in which the number of bins is reduced to the number of bins i of the target candidate histogram Q. Specifically, in Step S109, the following processing is executed. Thereafter, the processing proceeds to Step S110.

Step S109.1: By extracting bins from a bin[0] to a bin[i−1] from the reference histogram P₂, a reference histogram Pᵣₒᵢ (=[P[0], P[1], . . . , P[i−1]]) is created.

Step S109.2: The total sum of outliers (=sum(P[i], P[i+1], . . . , P[2047])) is added to the bottom of the reference histogram Pᵣₒᵢ.

Step S109.3: By executing the following processing, a candidate histogram Q′ having a length of 128 is created.

(1) The number of bins n (n=i/128) to be merged is calculated.

(2) By merging consecutive bins in the reference histogram Pᵣₒᵢ by n in the following manner, the candidate histogram Q′ is created. Note that “h(arr)=sum(arr)/(the number of nonzero elements included in arr)” and “128n−1=i−1” are satisfied.

Q′=[h(Pᵣₒᵢ[0], . . . ,Pᵣₒᵢ[n−1]),h(Pᵣₒᵢ[n], . . . ,Pᵣₒᵢ[2n−1]), . . . ,h(Pᵣₒᵢ[127n], . . . ,Pᵣₒᵢ[128n−1])]

Step S109.4: By executing the following processing, the candidate histogram Q having a length of i is created. Note that, in the following description, “q(x)=Q′[floor(x/n)]” is satisfied when Pᵣₒᵢ[x]≠0 is satisfied, and “q(x)=0” is satisfied when Pᵣₒᵢ[x]=0 is satisfied. Herein, floor( ) is a floor function.

Q=[q(0),q(1), . . . ,q(i−1)]

Step S109.5: By normalizing each of the reference histogram Pᵣₒᵢ and the candidate histogram Q such that a total sum is 1.0, a reference histogram Pᵣₒᵢ′ and a candidate histogram Q″ are created.

Step S109.6: The Kullback-Leibler divergence d between the reference histogram Pᵣₒᵢ′ and the candidate histogram Q″ is calculated.

In Step S110 to Step S112, a scale factor s is calculated. The threshold value acquisition unit 29 determines an integer i which minimizes the Kullback-Leibler divergence d between the reference histogram Pᵣₒᵢ′ and the candidate histogram Q″ (in other words, a difference between the probability distribution in the reference histogram Pᵣₒᵢ and the probability distribution in the candidate histogram Q is minimized) (Step S110). Subsequently, the threshold value acquisition unit 29 let m denote the integer i when the Kullback-Leibler divergence d is minimized, and calculates the threshold value t by using the following formula (Step S111). The scale factor calculation unit 30 calculates the scale factor s based on the threshold value t and the number of levels which can be represented in the fixed point format−1 (127 in the case of INT8) (Step S112). Thereafter, the processing shown in the present flowchart is ended.

threshold value t=(m+0.5)*bin width Δ

scale factor s=127/threshold value t

Thereafter, the quantization unit 31 uses the scale factor calculated in Step S111 as the scale factor when data represented in the floating point format (e.g., FP32) is quantized to data represented in the fixed point format (e.g., INT8) in the convolutional neural network.

In the present embodiment, in the calibration processing described with reference to FIGS. 4 and 5, when the bin range determination histogram P₁ and the reference histogram P₂ are created, data having a value 0 is excluded (for data having the value 0, the frequency value of the corresponding bin in the histogram is not incremented). Hereinbelow, a description will be given of the procedure of processing in the case where data having the value 0 is excluded when the histogram is created with reference to a flowchart.

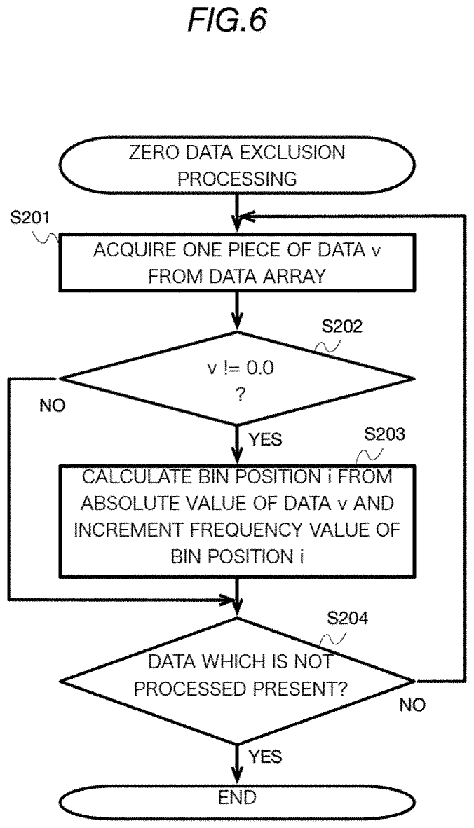

FIG. 6 is a flowchart showing the outline of the procedure of zero data exclusion processing according to the present embodiment. The processing shown in the present flowchart is executed when the histograms of input/output data of each layer in the CNN are created in addition to the calibration processing described with reference to FIGS. 4 and 5.

When each data in an input data set is set in the bin, each of the bin range determination histogram creation unit 24, the reference histogram creation unit 27, and the candidate histogram creation unit 28 (hereinafter simply referred to as “the histogram creation units 24, 27, and 28”) acquires one piece of data v from a data array (Step S201), and determines whether or not the data v is 0 (Step S202).

In the case where the acquired data v is not 0, each of the histogram creation units 24, 27, and 28 calculates a bin position i from the absolute value of the data v in a conventional manner, and increments the frequency value of the bin position i in the histogram (Step S203). On the other hand, in the case where the acquired data v is 0, each of the histogram creation units 24, 27, and 28 does not increment the frequency value of the bin position i of the data v. In the case where data which is not processed is present in the data array, the processing returns to Step S201 (Step S204). When the processing in Step S201 to Step S204 performed on all data in the data array is ended, the processing shown in the present flowchart is ended.

Note that, in the present embodiment, while the description has been given of the example in which both of the calibration processing described by using FIGS. 4 and 5 and the zero data exclusion processing described by using FIG. 6 are adopted, only one of the calibration processing and the zero data exclusion processing may also be adopted.

### Effect

According to the embodiment described above, it becomes possible to prevent a reduction in recognition accuracy in the convolutional neural network which performs quantization to data represented in the fixed point format.

Specifically, with regard to “Problem 1: Use of ReLU Function”, the reduction in recognition accuracy is prevented by excluding the value 0 when the histogram is created (the frequency value of the corresponding bin in the histogram is not incremented for the value 0).

In addition, with regard to “Problem 2: Use of Data Set Which Causes Extreme Outlier”, the reduction in recognition accuracy is prevented by creating the reference histogram P created in the conventional entropy calibration in two stages (the bin range determination histogram P₁ and the reference histogram P₂). More specifically, after the first histogram (the bin range determination histogram P₁) is created as usual, the threshold value which allows almost all (e.g., 99.99%) of the frequency values to fall within the bin range and is capable of excluding the outliers and the bin width of the second histogram (the reference histogram P₂) are determined by analyzing the first histogram. Next, the second histogram is created with the new bin width. At this point, values equal to or greater than the threshold value t determined by analyzing the first histogram are ignored.

### EXAMPLES

Next, a description will be given of specific examples in the case where the calibration processing and the zero data exclusion processing described in the above embodiment are adopted in the CNN.

### Example 1

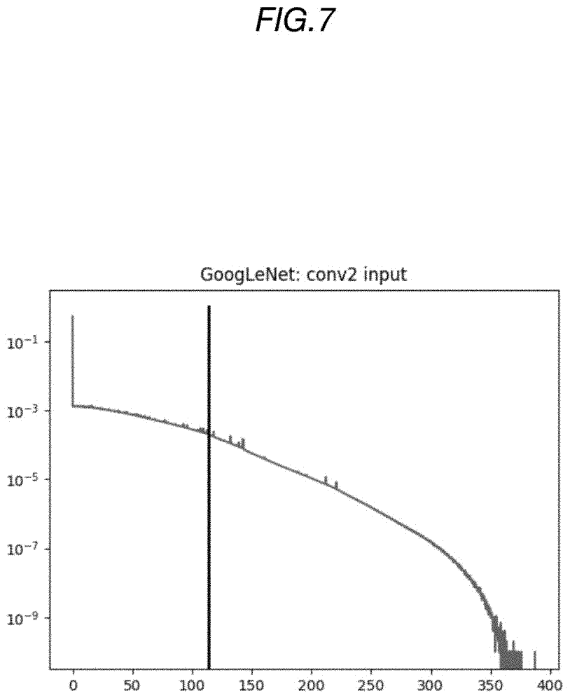

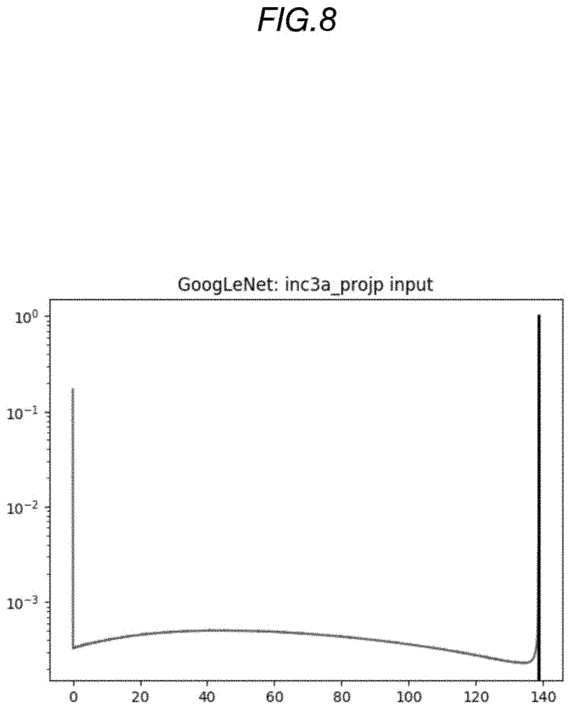

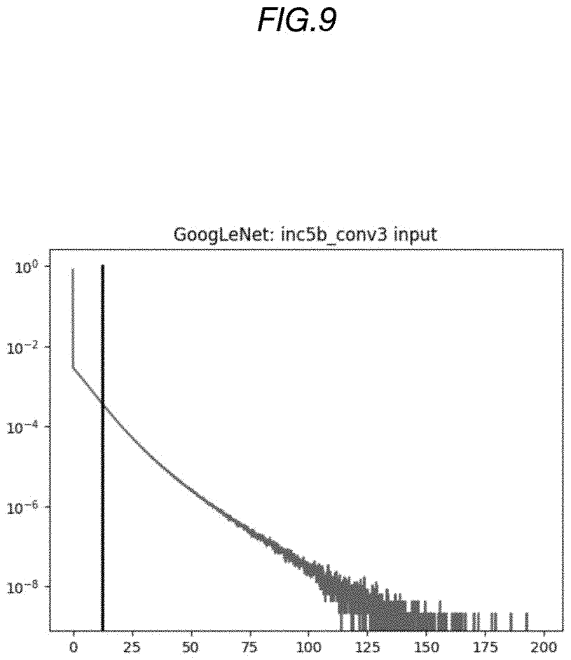

Each of FIGS. 7 to 9 is a view showing a reference histogram created with the conventional entropy calibration in the CNN including the ReLU function. In the reference histogram created with the conventional entropy calibration, an extremely high peak occurs at a value 0 (see FIGS. 7 to 9). This is because the entire negative portion of the output is integrated into one value 0 by the ReLU function. When such a data distribution is provided, the normalized frequency of the positive portion of the output is reduced, the scale factor becomes greater than the expected value, and the overflow or the underflow (the value has an integer value exceeding ±127 serving as the upper limit/the lower limit of INT8 and is clipped to ±127) often occurs. As a result, the recognition accuracy is significantly reduced.

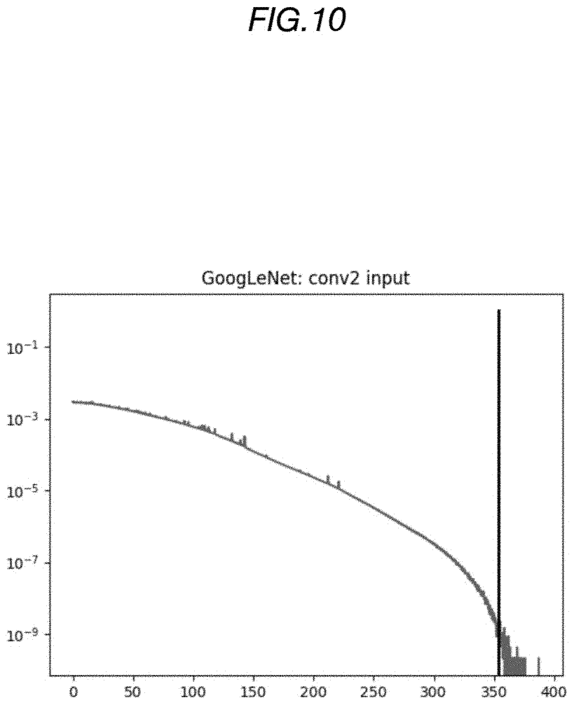

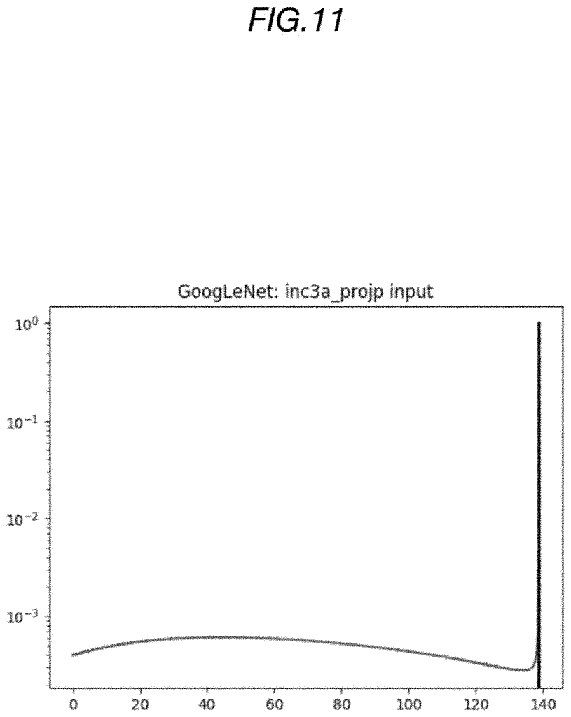

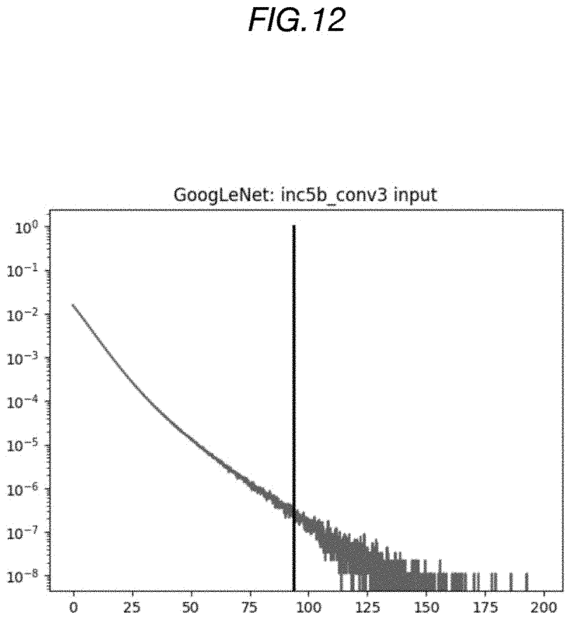

Each of FIGS. 10 to 12 is a view showing a reference histogram created with calibration which adopts the zero data exclusion processing in the CNN including the ReLU function. In the zero data exclusion processing described in the above embodiment, when the histogram is created, the value 0 is excluded (see the flowchart in FIG. 6). In the case where the above zero data exclusion processing is adopted, data distributions in FIGS. 7 to 9 are changed in a manner shown in FIGS. 10 to 12. A black vertical line in each of FIGS. 7 to 12 represents a threshold value at which clipping is performed during quantization and, when compared with FIGS. 7 to 9, it can be seen that the threshold value in each of FIGS. 10 to 12 is moved to the right and it is possible to perform the quantization without clipping values in a wider range, i.e., in a state in which loss of information is further reduced.

The recognition accuracy (Top-5 accuracy) was actually measured with validation data of the ILSVRC 2012 data set by using GoogLeNet (trademark) as the CNN, and the following improvements were observed.
quantization was not performed: 87.9%
quantization was performed and zero data exclusion processing was not performed: 1.2%
quantification and zero data exclusion processing were performed: 86.9%

### Example 2

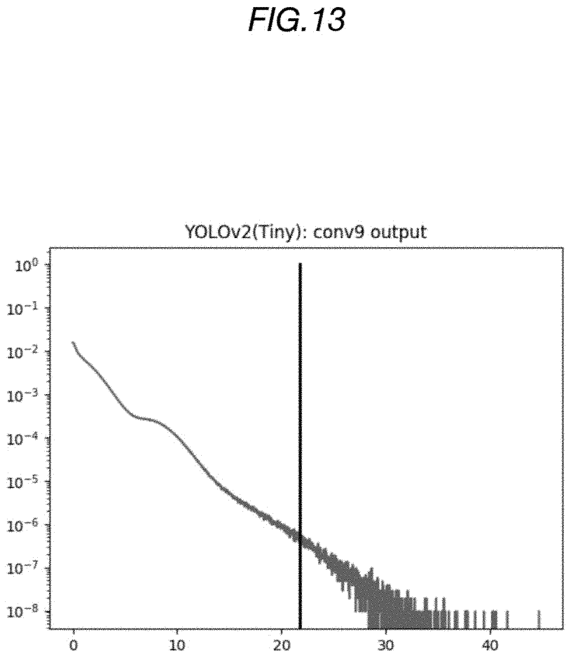

Consideration is given to YOLOv2 (Tiny) as an example of the CNN. This CNN uses, as an activating function, a Leaky ReLU function (ϕ(x)=max(0.1x, x)) (the gradient to a negative value is 0.1) instead of using the ReLU function. FIG. 13 is a view showing an example of a reference histogram created with the conventional entropy calibration performed on a specific layer of the CNN. At this point, a maximum value of the X axis (the absolute value of output) is about 44.7, and the bin width calculated based on the maximum value of the absolute value in a data set is 0.02 (=44.7/2047), and the threshold value is 21.7.

Herein, a state close to that in the case where a data set which causes extreme outliers is used is created by rewriting the maximum value (44.7) of the absolute value to a value which is 100 times the maximum value thereof in the conventional entropy calibration, and the reference histogram is created.

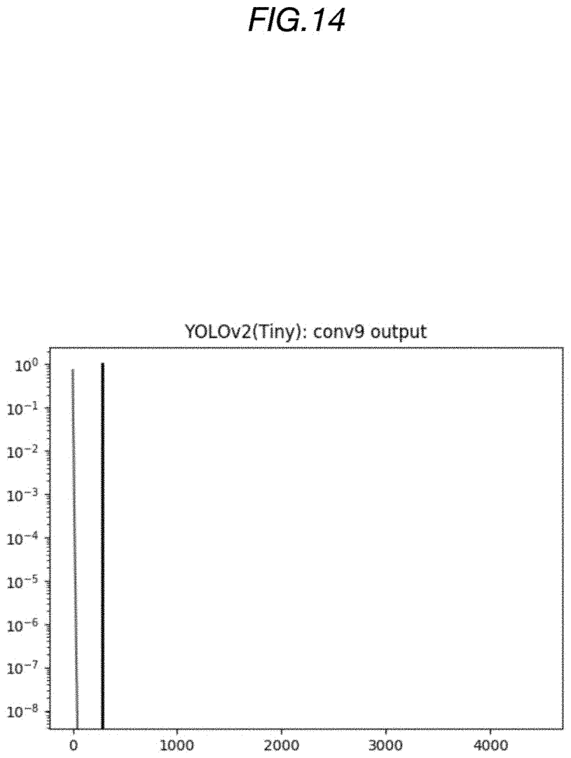

FIG. 14 is a view showing an example of the reference histogram in the case where the maximum value of the absolute value is rewritten to a value which is 100 times the maximum value thereof in the conventional entropy calibration. Under the condition of FIG. 14, the bin width calculated based on the maximum value of the absolute value in the data set is 2.18 (=4470/2047), and the histogram is 100 times as rough as the histogram in FIG. 13. The number of bins in the entire histogram is 2048, and hence all of the frequency values are concentrated in bins of the top 1% (=21 bins) in the histogram in FIG. 14. Note that the threshold value (280) is placed at the position of the frequency value 0 in FIG. 14 because a minimum value of the number of bins of the quantized candidate histogram Q created with the conventional entropy calibration is set to 128.

That is, in a situation in FIG. 14, the scale factor is deviated from an adequate value by a factor of 10 or more and, as a result, the recognition accuracy is significantly reduced.

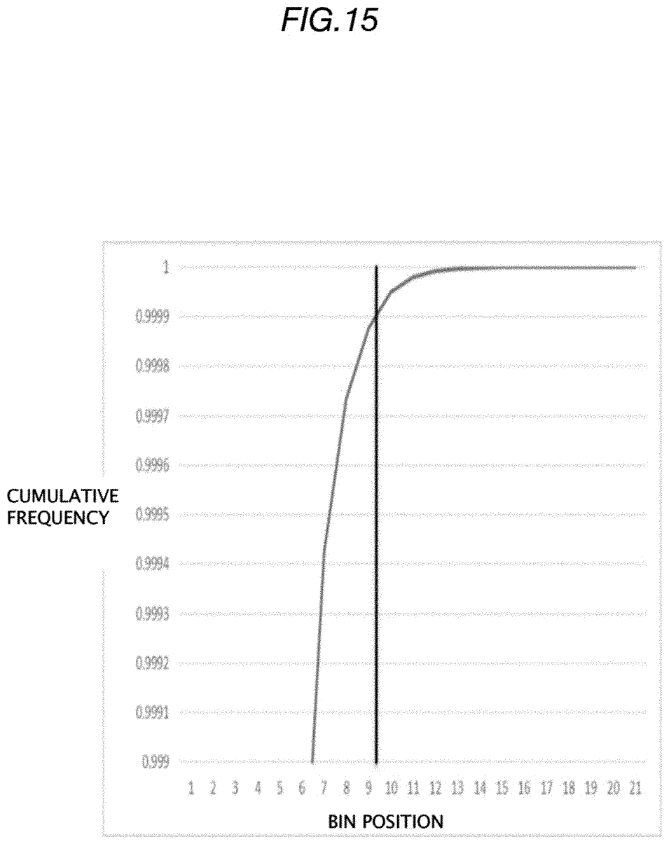

In contrast to this, in the calibration processing described in the above embodiment, the creation of the histogram is performed in two stages (see the flowcharts in FIGS. 4 and 5). FIG. 15 is a view showing a state in which Step S106 of the calibration processing according to the present embodiment is executed based on the histogram in FIG. 14. From a thick black line in FIG. 15, it can be seen that the bin position which allows 99.99% of the frequency values of the histogram in FIG. 14 to fall within the bin range is 10. At this point, the new bin width Δ₂ determined in Step S107 is 0.01 (=10×2.18/2047).

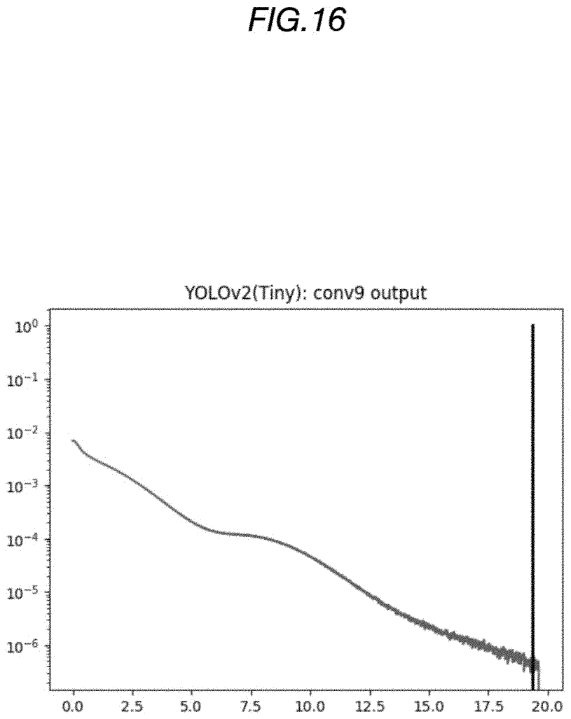

FIG. 16 is a view showing the reference histogram P₂ created in Step S108 in the calibration processing according to the present embodiment. The threshold value is determined to be 19.4 by performing the processing in and after Step S109 on the reference histogram P₂ in FIG. 16. This value is close to a value 21.7 determined from the histogram in FIG. 13, and a situation close to that in FIG. 13 is reproduced (values having absolute values greater than the threshold value represented by the black vertical line are clipped to an upper limit/a lower limit).

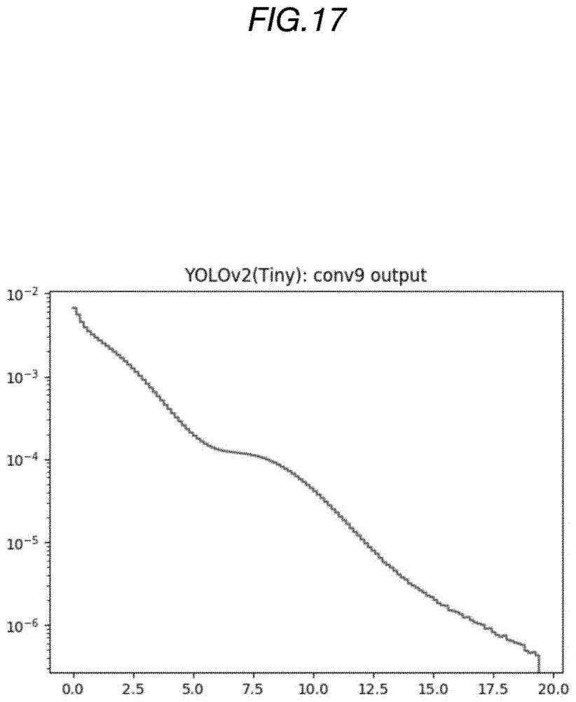

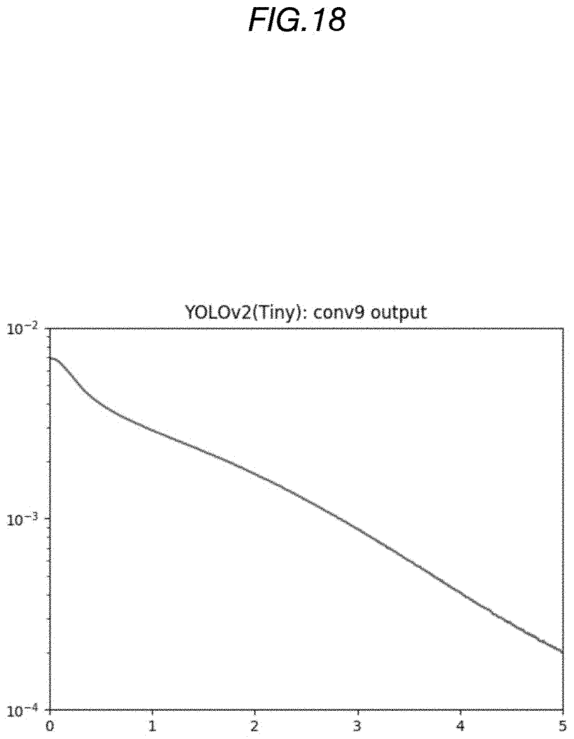

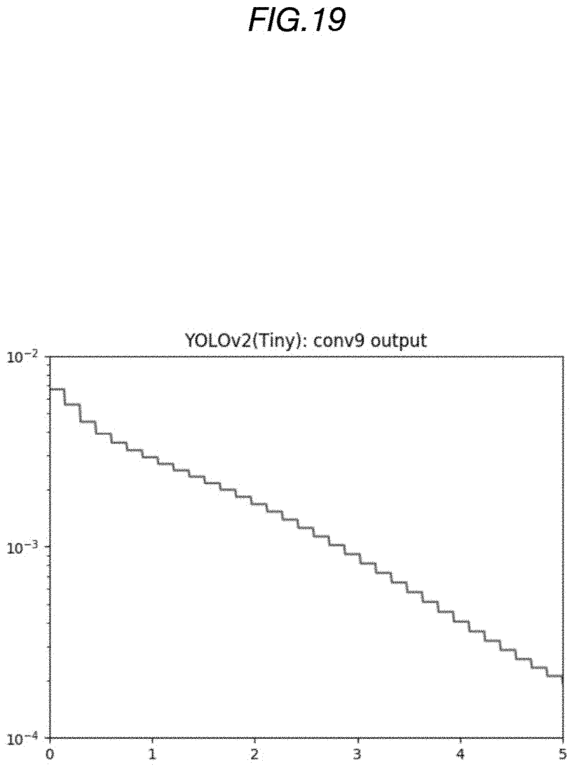

Note that FIG. 17 is a view showing the candidate histogram Q when the processing in and after Step S109 is executed based on the reference histogram P₂ in FIG. 16, and the Kullback-Leibler divergence is minimized. FIGS. 18 and 19 are enlarged views of top ¼ portions of FIGS. 16 and 17.

The recognition accuracy (mean average precision (mAP)) was actually measured by using test data of the PASCAL VOC 2007 data set in the CNN used in verification, and the following improvements were observed.
quantization was not performed: 52.5%
quantization was performed, a maximum value of a specific layer was changed to a value which is 100 times the maximum value, and calibration processing was not performed: 33.5%
quantization was performed, the maximum value of the specific layer was changed to the value which is 100 times the maximum value, and calibration processing was performed: 51.9%

What is claimed is:

1. An information processing apparatus performing operation of a convolutional neural network, the information processing apparatus comprising a processor to:
determine a first bin width on the basis of a maximum value in a plurality of pieces of data represented in a floating point format;
create a bin range determination histogram by assigning each of the plurality of pieces of data to bins on the basis of the first bin width;
determine a bin range, within which a predetermined percentage or more of the plurality of pieces of data fall, by referring to the bin range determination histogram;
determine a second bin width on the basis of the number of pieces of data in the bin range; and
create a reference histogram by assigning each of a plurality of pieces of data in the bin range to bins on the basis of the second bin width.

2. The information processing apparatus according to claim 1, wherein the processor further:
converts the plurality of pieces of data to a fixed point format by quantizing data in a range in which a value is determined by a threshold value, to data in a range below a maximum value or above a minimum value that can be represented in a predetermined fixed point format, and assigning data outside the range in which the value is determined by the threshold value, to the maximum value or the minimum value;
create a candidate histogram by assigning each of the plurality of pieces of data in the floating point format to any number of bins; and
compares a distribution in the reference histogram with a distribution in the candidate histogram and acquires the threshold value with which a difference between the distributions is reduced.

3. The information processing apparatus according to claim 2, wherein the processor further calculates a scale factor for converting the plurality of pieces of data represented in the floating point format the predetermined fixed point format on the basis of the acquired threshold value and the number of levels that can be represented in the predetermined fixed point format, and
wherein the processor converts the plurality of pieces of data represented in the floating point format to the predetermined fixed point format by using the scale factor.

4. The information processing apparatus according to claim 1, wherein the processor determines the first bin width by dividing the maximum value in the plurality of pieces of data represented in the floating point format by a predetermined number of bins.

5. The information processing apparatus according to claim 1, wherein the processor determines the second bin width by dividing a value which is obtained by multiplying the number of pieces of data in the bin range by the first bin width, by a predetermined number of bins.

6. The information processing apparatus according to claim 1, the processor further acquires data represented in the floating point format in which a negative value included in a convolution operation result is replaced with 0, and
wherein the processor creates the reference histogram by assigning, among the plurality of pieces of data, a piece of data having a value other than 0 to each bin on the basis of a predetermined bin width, and not assigning, among the plurality of pieces of data, a piece of data having a value 0 to any of the bins.

7. An information processing apparatus performing operation of a convolutional neural network, the information processing apparatus comprising a processor to:
acquire a plurality of pieces of data represented in a floating point format, in which a negative value included in a convolution operation result is replaced with 0; and
create a reference histogram by assigning, among the plurality of pieces of data, a piece of data having a value other than 0 to bins on the basis of a predetermined bin width, and not assigning, among the plurality of pieces of data, a piece of data having a value 0 to any of the bins.

8. The information processing apparatus according to claim 7, the processor further executes quantization for converting the plurality of pieces of data to a plurality of pieces of data represented in a fixed point format by quantizing data in a range, in which a value is determined by a threshold value, to data in a range below a maximum value or above a minimum value, which can be represented in a predetermined fixed point format, and assigning data outside the range, in which the value is determined by the threshold value, to the maximum value or the minimum value;
candidate histogram creation for creating a candidate histogram by assigning each the plurality of pieces of data to any number of bins without converting the floating point format of the plurality of pieces of data; and
threshold value acquisition for comparing a distribution in the reference histogram with a distribution in the candidate histogram and acquiring the threshold value which reduces a difference between the distributions.

9. The information processing apparatus according to claim 8, wherein the processor further calculates a scale factor for converting the plurality of pieces of data represented in the floating point format the predetermined fixed point format on the basis of the acquired threshold value and the number of levels that can be represented in the predetermined fixed point format, and
Wherein the processor converts the plurality of pieces of data represented in the floating point format to the predetermined fixed point format by using the scale factor.

10. A method causing a computer performing operation of a convolutional neural network to execute:
determining a first bin width on the basis of a maximum value in a plurality of pieces of data represented in a floating point format;
creating a bin range determination histogram by assigning each of the plurality of pieces of data to bins on the basis of the first bin width;
determining a bin range, within which a predetermined percentage or more of the plurality of pieces of data fall, by referring to the bin range determination histogram;
determining a second bin width on the basis of the number of pieces of data in the bin range; and
creating a reference histogram by assigning a plurality of pieces of data in the bin range to bins on the basis of the second bin width.

11. A method causing a computer performing operation of a convolutional neural network to execute:
acquiring a plurality of pieces of data represented in a floating point format in which a negative value included in a convolution operation result is replaced with 0; and
creating a reference histogram by assigning, among the plurality of pieces of data, a piece of data having a value other than 0 to bins on the basis of a predetermined bin width, and not assigning, among the plurality of pieces of data, a piece of data having a value 0 to any of the bins.

12. A non-transitory computer-readable recording medium on which is recorded a program for causing a computer performing operation of a convolutional neural network to execute a process comprising:
determining a first bin width on the basis of a maximum value in a plurality of pieces of data represented in a floating point format;
creating a bin range determination histogram by assigning each of the plurality of pieces of data to bins on the basis of the first bin width;
determining a bin range, within which a predetermined percentage or more of the plurality of pieces of data fall, by referring to the bin range determination histogram;
determining a second bin width on the basis of the number of pieces of data in the bin range; and
creating a reference histogram by assigning each of a plurality of pieces of data in the bin range to bins on the basis of the second bin width.

13. A non-transitory computer-readable recording medium on which is recorded a program for causing a computer performing operation of a convolutional neural network to execute a process comprising:
acquiring a plurality of pieces of data represented in a floating point format in which a negative value included in a convolution operation result is replaced with 0; and
creating a reference histogram by assigning, among the plurality of pieces of data, a piece of data having a value other than 0 to bins on the basis of a predetermined bin width, and not assigning, among the plurality of pieces of data, a piece of data having a value 0 to any of the bins.
